(19) United States
(12) Patent Application Publication
(10) Pub. No.: US 2001/0038478 A1
(43) Pub. Date: Nov. 8, 2001

(54) Structure of a bidirectional wavelength optical function module

(75) Inventor: Yu-Wen Hwang, Hsinchu (TW)

Correspondence Address: Daniel R. McClure, THOMAS, KAYDEN, HORSTEMEYER & RISLEY, L.L.P., Suite 1750, 100 Galleria Parkway N.W., Atlanta, GA, 30339, US

(73) Assignee: Browave Corporation, Hsinchu (TW)

(21) Appl. No.: 09/768,483

(22) Filed: Jan. 23, 2001

(30) Foreign Application Priority Data
Apr. 29, 2000 (TW) 89108212

(51) Int. Cl. H04J 14/02

(52) U.S. Cl. 359/124; 359/134

(57) ABSTRACT

An optical function module for bi-directional wavelength-division multiplexer (WDM) optical communication system comprises at least one wavelength managing module, and at least one uni-directional optical function module. The wavelength managing module has a plurality of ports, and optically couples between a first optical transceiver and a second optical transceiver, wherein the first and the second optical transceivers provides a first and a second optical channels respectively for transmitting a plurality of optical signals with different wavelengths. The uni-directional optical function module has a high isolation function, and couples to the ports of the wavelength managing module. In addition, the uni-directional optical function module with high isolation can be replaced by an uni-directional optical function module without high isolation and an optical isolator.

### CROSS-REFERENCE TO RELATED APPLICATION

This application claims the priority benefit of Taiwan application Ser. No. 89108212, filed Apr. 29, 2000.

### FIELD OF INVENTION

The present invention relates to an optical function module for an optical communication system. More particularly, the present invention relates to an optical function module for a bi-directional wavelength optical communication system.

### DESCRIPTION OF RELATED ART

Optical systems having high transmission efficiency are presently being employed in the communication of voice and video information, as well as in high-speed data transmission. Optical communication systems are desirable since they provide wide bandwidths which may be used for the information channels, among other functions. Although wide bandwidths are available, many of the existing optical communication systems use one directional communication for each optical fiber. Some existing optical communication systems are described below for purposes of discussing their shortcomings.

FIG. 1 shows a bi-directional amplifier module, U.S. Pat. No. 5,452,124, being constructed using a single erbium-doped fiber amplifier (EDFA). More particularly, FIG. 1 shows a conventional bi-directional optical fiber transmission system for transceiving a number of optical signals having different wavelengths λ1, λ2, . . . , λn. A first optical transceiver 12a includes a transmitting end TX1 and a receiving end RX1, while a second optical transceiver 12b includes a transmitting end TX2 and a receiving end RX2. Optical signals having various wavelengths λ1, λ2, . . . , λn are emitted from the transmitting end TX1 of the first optical transceiver 12a, transmitted through a number of EDFA 16 for amplifying the optical signals, and then received at the receiving end RX2 of the second optical transceiver 12b. Similarly, optical signals having various wavelengths λ1, λ2, . . . , λn can also be emitted from the transmitting end TX2 of the second optical transceiver 12b, transmitted through a number of EDFA 16 for amplifying the optical signals, and then received at the receiving end RX1 of the second optical transceiver 12a. However, under this architecture, each of optical fibers 14a, 14b can be only used for one directional transmission, and a number of EDFA amplifiers 16 must be connected to the optical fibers 14a, 14b in series, serving as line-amplifiers.

FIG. 2 shows a conventional bidirectional amplifier module, U.S. Pat. No. 5,458,124, in which only one EDFA 24 is used for performing bidirectional transmissions through a single optical fiber. In addition, wavelength-division multiplexers (WDM) are used for performing bidirectional transmission. As shown by FIG. 2, optical signals are emitted from the transmitting end TX1 of the optical transceiver 21a, transmitted through the optical fiber 26, and then transmitted to the WDM 23b through the optical fiber 26 of the WDM 23a, 22c. The WDM 23b can receive the optical signals from the optical fiber 26 or 28 and then output to the EDFA 24 for purposes of amplifying the optical signals. The amplified optical signals are transmitted to the receiving end RX2 of the optical transceiver 21b through the WDM 22b, 21a 23c and 22a. Similarly, the optical signals can be emitted from the transmitting end TX2 of the optical transceiver 21b and then transmitted to the receiving end RX1 of the optical transceiver 21a, in the same manner.

FIG. 3 shows a conventional Baker's optical communication system using a single optical fiber bi-directional amplifier module. The Baker's optical communication system uses a four-port WDM filter 35 and an amplifier 36, which is a single EDFA, to achieve functions.

FIG. 4 shows a structure of the four-port WDM filter shown in FIG. 3. The amplifier module 34 consists of a four-port WDM filter 35 having ports P1˜P4 and an EDFA 36. As shown by FIG. 3, optical signals having wavelengths λ1 are emitted from a transmitting end TX (λ1) of an optical transceiver 32a, and then transmitted to the amplifier module 34 at port P1 of the four-port WDM filter 35 through the optical fiber 37. And the optical signal is outputted from port P3 to the EDFA 36 for amplifying the optical signals. Thereafter, the amplified optical signals are transmitted back to the amplify module 34 at port P4 of the four-port WDM filter 35, and then outputted from port P2 to the receiving end RX (λ1) of a WDM 32b within an optical transceiver 32a through the optical fiber 37. Similarly, optical signals with wavelength λ2 are emitted from a transmitting end TX (λ2) of an optical transceiver 32b, and then transmitted to the EDFA 36 through ports P2 and P3. Thereafter, the amplified optical signals are transmitted back to the WDM filter 35 at port P4, and then transmitted to the receiving end RX (λ2) of the optical transceiver 30a from port P1.

The structure of the four-port WDM filter 35 is shown in FIG. 4. The four-port WDM filter 35 comprises a multi-layer dielectric substrate 35a, a lens 35b and four ports P1˜P4 for input/output of the optical signals. The substrate 35a is designed such that only the optical signals with wavelength λ2 can be passed, and other optical signals with wavelength other than λ2 are blocked and reflected. Therefore, when optical signals having wavelengths λ1 are transmitted to the four-port WDM filter 35, through port P1, they are then reflected by the substrate 35a and outputted at port P3. After being amplified by the EDFA 36, the optical signals with wavelengths λ1 and λ2 are transmitted to the port P4 of the four-port WDM filter 35, being focused at the right side (referring to the drawing sheet) of the lens 35b. Optical signals having wavelengths λ1 are then reflected to port P2 by the substrate 35a and transmitted to the optical transceiver 32b. The optical signals having wavelengths λ2 pass through the substrate 35a, and are reflected to port P1, and are then transmitted to the optical transceiver 32a. However, the structure mentioned above has the shortcoming of low isolation, and of insertion loss when applied to multi-wavelength applications.

FIG. 5 shows another conventional structure of the bi-directional optical amplifier module, U.S. Pat. No. 5,633,741. This structure utilizes two optical circulators 50a, 50b for transmitting and receiving optical signals. Four channels f1˜f4 can be used for transceiving optical signals, but two EDFAs 52a, 52b are needed. Therefore, the whole system becomes very large when the system is applied to multi-wavelength applications.

FIG. 6 shows a structure of a bi-directional amplifier, U.S. Pat. No. 5,748,363. The amplifier module 62 has two input optical fibers 64a, 64b for carrying optical signals λ1, λ2 and λ3,λ4 respectively. The ends of the input optical fibers 64a, 64b are further connected to four-port circulators 62a and 62b respectively. An EDFA 62c is connected between port P4 of circulator 62a and port P1 of circulator 62b, and used for transmitting optical signals in one direction. Therefore, the structure uses the four-port optical circulators 62a, 62b and the uni-directional EDFA 62c for performing bi-directional transmission of four different wavelengths. However, this structure is difficult for applying to multi-wavelength applications.

As the foregoing discussions, each optical fiber of the conventional optical amplifier module can only perform transmissions in one direction, and a number of EDFAs must be connected to the optical fiber, to serve as a line-amplifier. In addition, the conventional optical amplifier module has the drawback of low-isolation when the optical signals are reflected and has a large insertion-loss when applied to multi-wavelength applications.

### SUMMARY OF THE INVENTION

The invention provides an optical function module for a bi-directional wavelength-division multiplexer (WDM) optical communication system. The optical function module comprises at least one wavelength managing module and at least one uni-directional optical function module. The wavelength managing module has a number of ports, such as, for example, four ports, and is optically coupled between a first optical transceiver and a second optical transceiver, wherein the first and the second optical transceivers provide first and second optical channels respectively for transmitting a plurality of optical signals with different wavelengths. The uni-directional optical function module has a high isolation function and is coupled to the ports of the wavelength managing module.

In addition, the uni-directional optical function module with high isolation function mentioned above can be an optical amplifier module, or a chromatic dispersion compensator. The wavelength managing module can be, for example, a multi-window wavelength-division multiplexer (MWDM).

The optical function module may also comprise at least one wavelength managing module, at least one uni-directional optical function module, and at least one optical isolator. In such a case, the wavelength managing module has a number of ports, such as four ports, and is optically coupled between a first optical transceiver and a second optical transceiver, wherein the first and the second optical transceivers provide for first and second optical channels respectively for transmitting a plurality of optical signals with different wavelengths. The uni-directional optical function module is coupled to the ports of the wavelength managing module. The optical isolator is optically coupled between the wavelength managing module and the uni-directional optical function module.

As an example, the uni-directional optical function module mentioned above can be an optical add/drop module or an uni-directional optical crossconnect coupling to the ports of the wavelength managing module. Further, the wavelength managing module can be a multi-window wave-division multiplexer (MWDM).

The present invention further provides a bi-directional wavelength multiplexer optical communication system, for automatically switching optical signals. The system comprises a number of wavelength managing modules, at least one uni-directional wavelength crossconnect, and a number of optical isolators. Each of the wavelength managing modules has a plurality of ports, and one of the ports is connected to a first optical transceiver and another port is connected to a second optical transceiver. The first and the second optical transceivers respectively provide first and second optical channels for transmitting a plurality of optical signals with different wavelengths. The uni-directional wavelength crossconnect is optically connected between the ports of the wavelength managing modules. Each of the optical isolators is optically connected between the uni-directional optical crossconnect and each of the wavelength managing modules.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a bi-directional amplifier module constructed using a single erbium-doped fiber amplifier (EDFA).

FIG. 2 shows a conventional bidirectional amplifier module in which only one EDFA is used for performing bidirectional transmissions through a single optical fiber.

FIG. 3 shows a conventional Baker's optical communication system using a single optical fiber bi-directional amplifier module.

FIG. 4 shows a structure of the four-port WDM filter shown in FIG. 3.

FIG. 5 shows another conventional structure of bi-directional optical amplifier module.

FIG. 6 shows a structure of a bi-directional amplifier.

FIG. 7 schematically illustrates a block diagram of an optical communication system according to the preferred embodiment of the present invention.

FIG. 8 schematically illustrates a first example of the optical function module shown in FIG. 7.

FIG. 9 shows a spectrum for a typical MWDM.

FIG. 10A schematically shows a second example of the optical function module shown in FIG. 7, which can be used for adding and dropping one or a number of special wavelengths within optical signals.

FIG. 10B schematically shows a spectrum diagram wherein an optical isolator is not inserted into the structure shown in FIG. 10A.

FIG. 10C schematically shows a spectrum diagram wherein an optical isolator is inserted into the structure shown in FIG. 10A.

FIG. 11 schematically shows a third example of the optical function module shown in FIG. 7, which is capable of compensating a chromatic dispersion due to the long-distance propagation.

FIG. 12 schematically shows a block diagram of a system containing a number of optical communication systems for exchanging the information among these optical communication systems.

FIG. 13 schematically shows a detailed structure of the bi-directional wavelength crossconnect shown in FIG. 12.

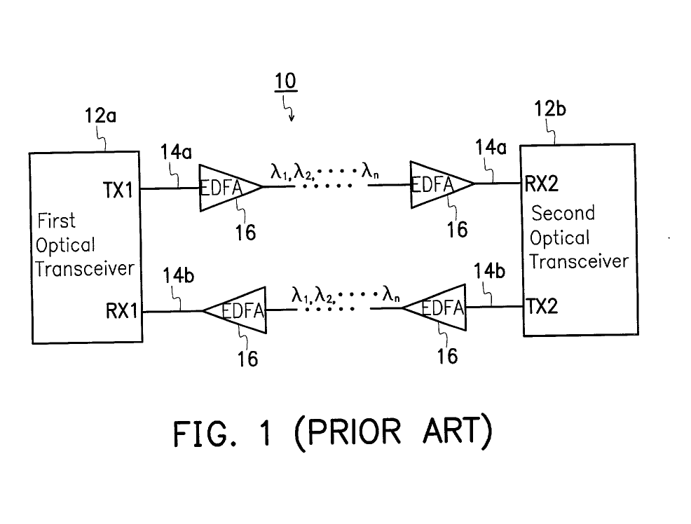

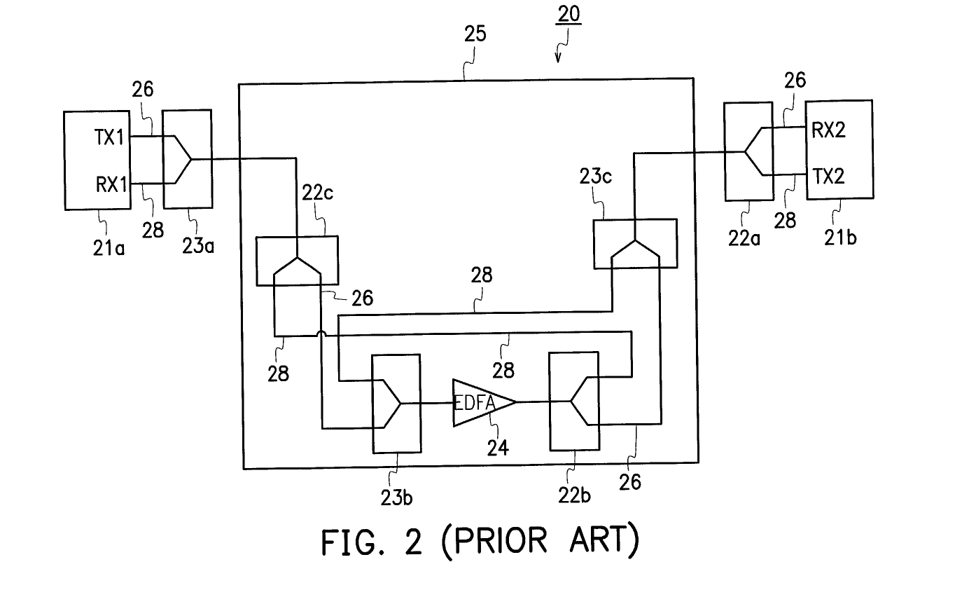

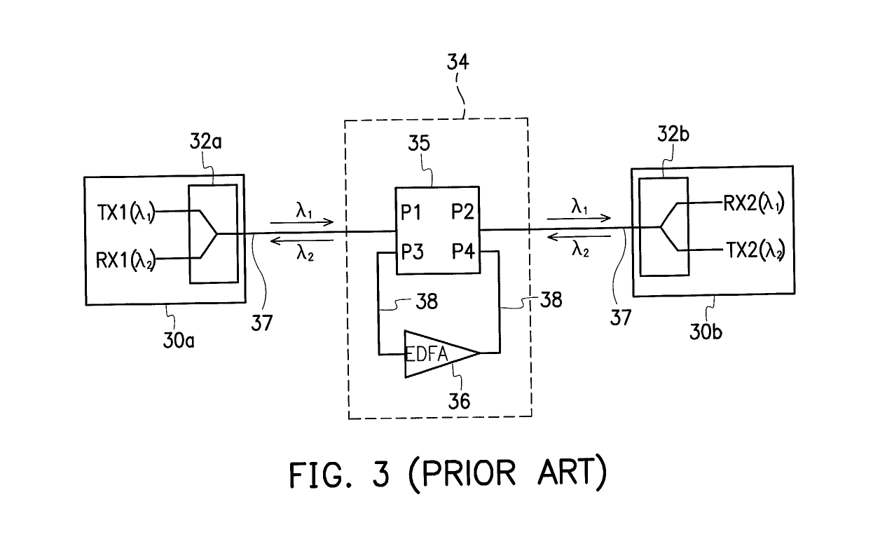

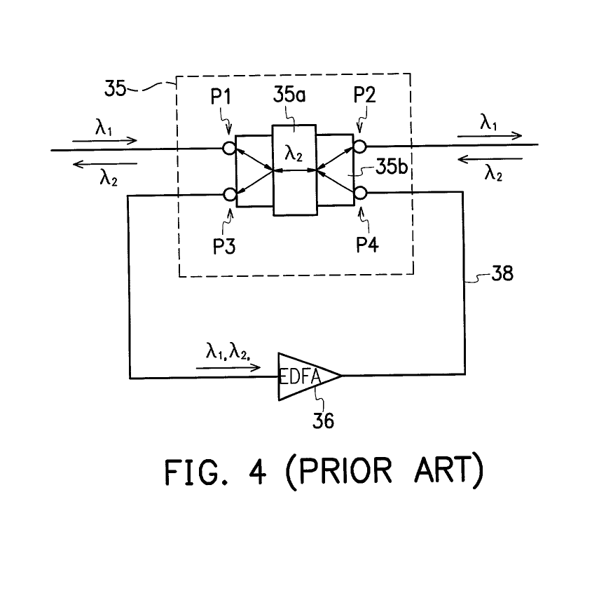

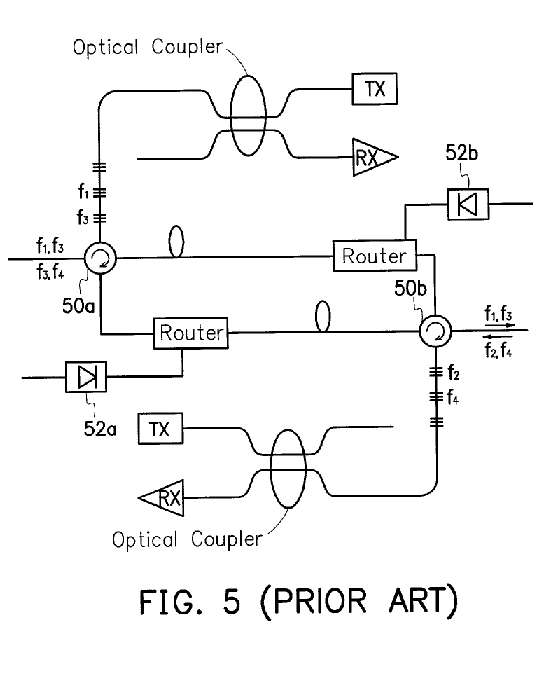

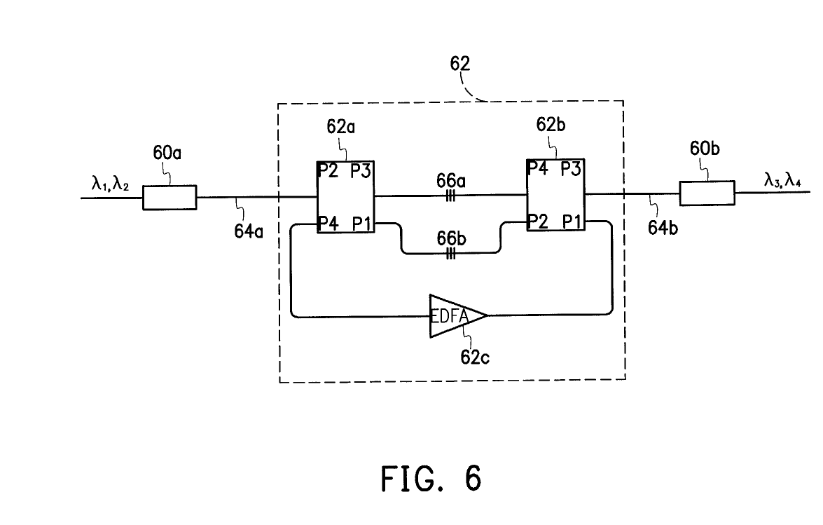

### DESCRIPTION OF THE PREFERRED EMBODIMENTS

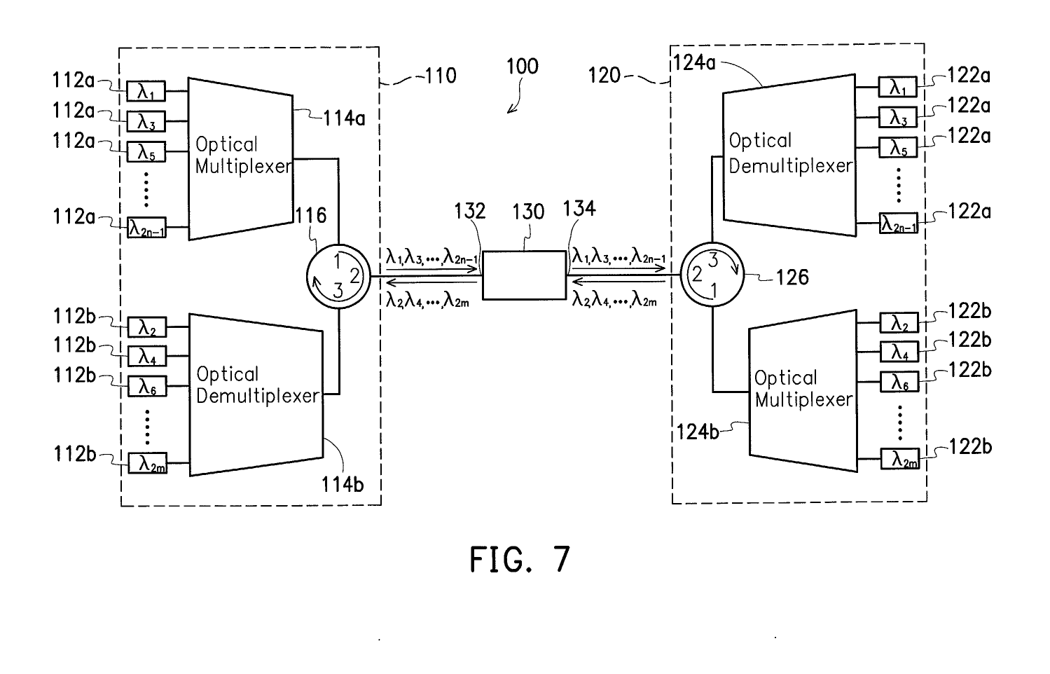

FIG. 7 schematically illustrates a block diagram of an optical communication system according to one preferred embodiment of the present invention. As shown in FIG. 7, the optical communication system 100 comprises a first optical transceiver module 110, a second optical transceiver module 120 and an optical function module 130. The first optical transceiver module 110 comprises a number of optical transmitters 112a for emitting optical signals having wavelengths λ1,λ3, . . . ,λ2n−1 (n is an integer). The optical signals having wavelengths λ1,λ3, . . . ,λ2n−1 are then transmitted to an optical multiplexer 114a for combining all of the optical signals. The combined optical signals are then transmitted to port 1 of a three-port optical circulator 116 through an optical transmission path, such as an optical waveguide. The three-port optical circulator 116 is used for circularly changing optical paths in one direction. For example, optical signals are inputted to port 1 of the circulator 116 and then directed to port 2 for outputting; optical signals are inputted to port 2 of the circulator 116 and then directed to port 3 for outputting. An optical transmission path 132 is used for transmitting the optical signals from the circulator 116 to the optical function module 130. The optical signals are processed within the optical function module 130 and then transmitted to the second optical transceiver 120.

The second optical transceiver 120 has the same structure as the first optical transceiver 110. When the second optical transceiver 120 receives the optical signals from the optical function module 130, the optical signals are received at port 2 of the circulator 126 and then directed to port 3 for outputting to an optical demultiplexer 124a through a waveguide. The optical demultiplexer 124a then decomposes the combined optical signals to the optical signals having wavelengths λ1,λ3, . . . ,λ2n−1, which are the signals emitted from the transmitters 112a. The optical signals having wavelengths λ1,λ3, . . . ,λ2n−1 are then received by the receivers 122a respectively.

The above mentioned optical signals emitted from the first transceiver 110 are information-bearing optical signals, which comprise data that can be transmitted through optical transmission medium, such as audio information, video information or general computer data.

Similarly, optical signals having wavelengths λ2,λ4, . . . ,λ2m, are emitted from the optical transmitters 122b respectively, and then combined by the optical multiplexer 124b. The combined optical signals are then transmitted to port 1 of the circulator 126, and then directed to port 2. The optical signals are transmitted to the optical function module via the circulator 126, and finally to the first optical transceiver 110. The detail process is the same as above descriptions.

The optical circulators 116, 126 mentioned above can be the commercially available products from JDS-Fitel, Canada, or E-Tek, San Jose, Calif. In addition, the optical transmission paths 132, 134 can be a single-mode optical fiber, such as SMF-28 commercially available from Corning, AT&T Corp./Lucent Technologies. Any optical waveguide capable of transmitting multiple optical wavelengths can be used as the optical transmission paths.

At least one optical function module 130 can be used to connect between the first and the second optical transceivers 110, 120. The optical function module 130 can be used for amplifying the optical signals, adding and dropping one or a number of specified wavelengths, compensating the chromatic dispersion for the input optical signals, or switching the optical paths for different wavelengths. The optical function module 130 is also a significant feature of the present invention. Therefore, several possible examples are provided below.

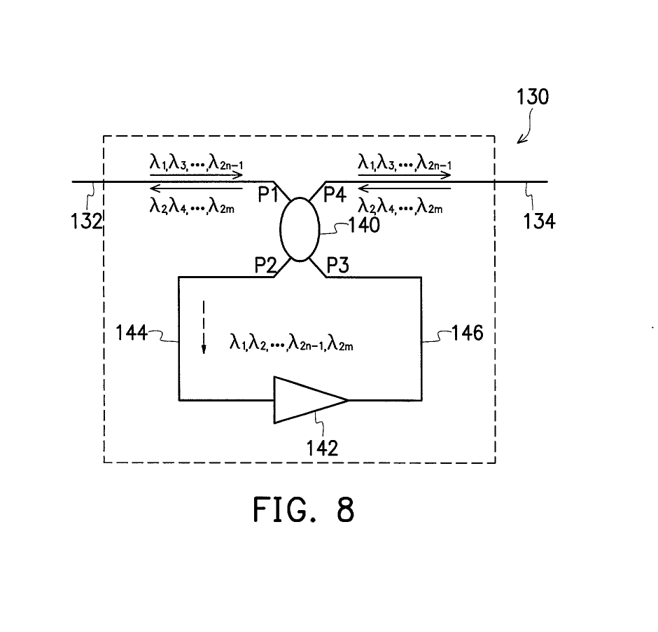

FIG. 8 schematically illustrates a first example of the optical function module shown in FIG. 7. As shown in FIG. 8, the optical function module 130 comprises a wavelength managing module 140 and an optical amplifier 142. The wavelength managing module 140 has four ports used for input/output. For example, port P1 of the wavelength managing module 130 is optically coupled to the optical transmission path 132, and used for receiving the optical signals having wavelengths λ1, λ3, . . . , λ2n−1, or outputting the optical signals having wavelengths λ2,λ4, . . . , λ2m, shown in FIG. 7. Port P4 of the wavelength managing module 130 is optically coupled to the optical transmission path 134, and used for receiving the optical signals having wavelengths λ2, λ4, . . . , λ2m or outputting the optical signals having wavelengths λ1, λ3, . . . , λ2n−1, shown in FIG. 7.

Port P2 of the wavelength managing module 140 is connected to the input of the optical amplifier 142 through the optical transmission path 144, and the output of the optical amplifier 142 is connected to port P3 of the wavelength managing module 140 through the optical transmission path 146. As an example, optical amplifier 142 and the wavelength managing module can be connected by optical fibers or optical waveguide. The optical amplifier 142 is used for amplifying all of the optical signal having wavelengths λ1, λ2, . . . , λ2m. In addition, the optical transmission paths 144, 146 are designed to transmit the optical signals in one direction.

Typically, the optical amplifier 142 can be an erbium-doped fiber amplifier (EDFA), which includes an optical isolator, a WDM (980/1550 nm or 1480/1550 nm), an erbium-doped fiber and a pump source (such as a 980 nm or 1480 nm laser diode). The wavelength managing module 140 can be a multi-window wavelength division multiplexer (MWDM), which can be made by using a long fused-biconical taper (FBT) method, or an unbalanced Mach-Zehnder interferometer (UMZI) method.

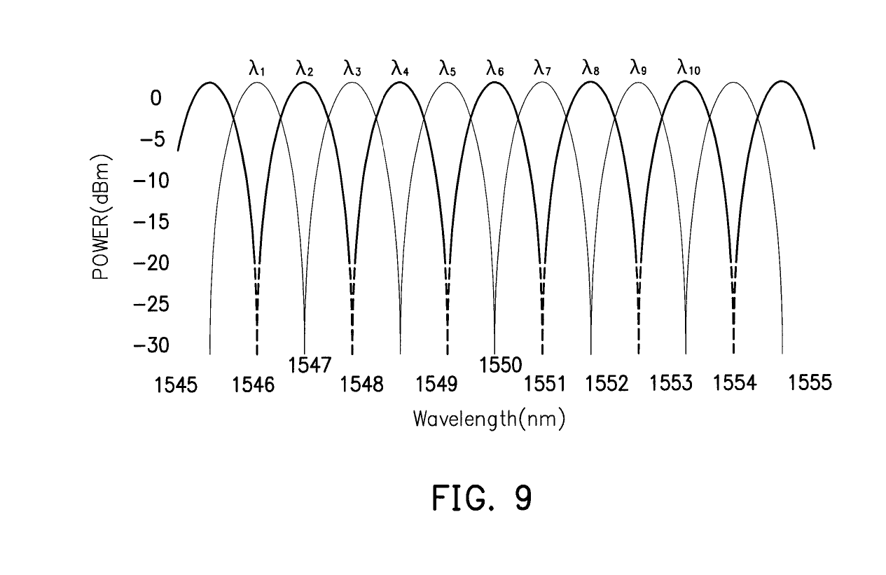

FIG. 9 shows a spectrum for a typical MWDM. If a white light source is launched into port P1 of the wavelength managing module 140, the spectrum having peak wavelength marked λ1, λ3, . . . , λ2n−1 (odd number) appears at port P2 of the wavelength managing module 140, and the spectrum having peak wavelength marked λ2, λ2, . . . , λ2m (even number) appear at port P3 of the wavelength managing module 140. Due to the symmetric property of the MWDM module 140, if a white light source is launched into the port P3 of the wavelength managing module 140, the spectrum having peak wavelength marked λ1, λ3, . . . , λ2n−1 (odd number) appears at port P4 of the wavelength managing module 140 and the spectrum having peak wavelength marked λ2, λ2, . . . , λ2m (even number) appears at port 1 of the wavelength managing module 140.

Both of the optical signals emitted from the first and the second optical transceivers 110, 120 are passed through the wavelength managing module 140 twice. Therefore, the channel isolation for these optical signals is doubled.

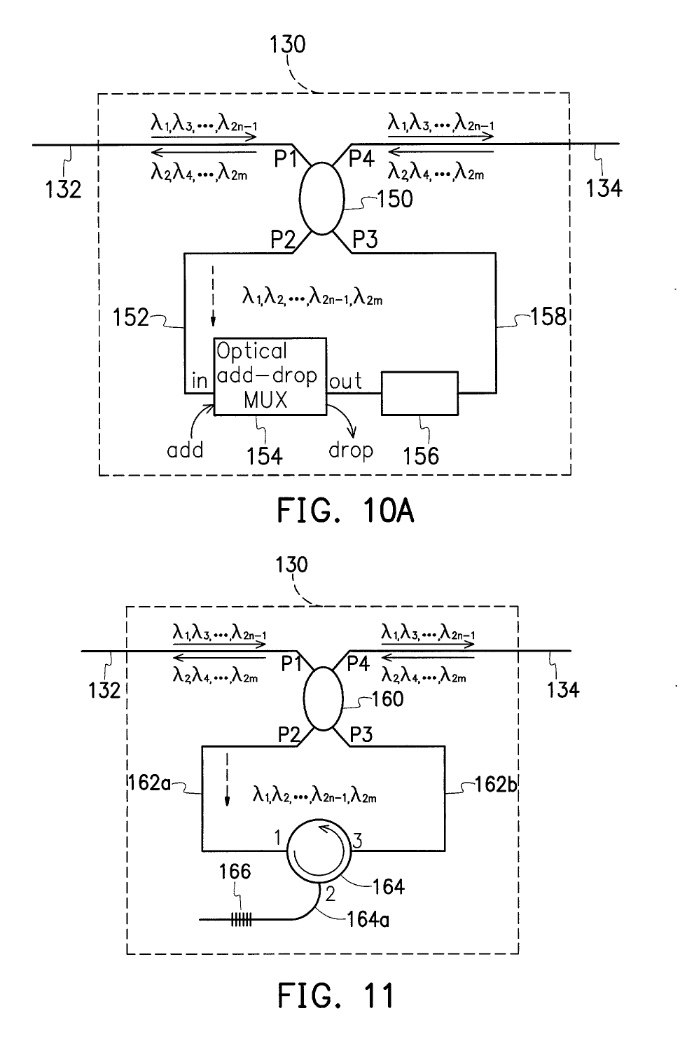

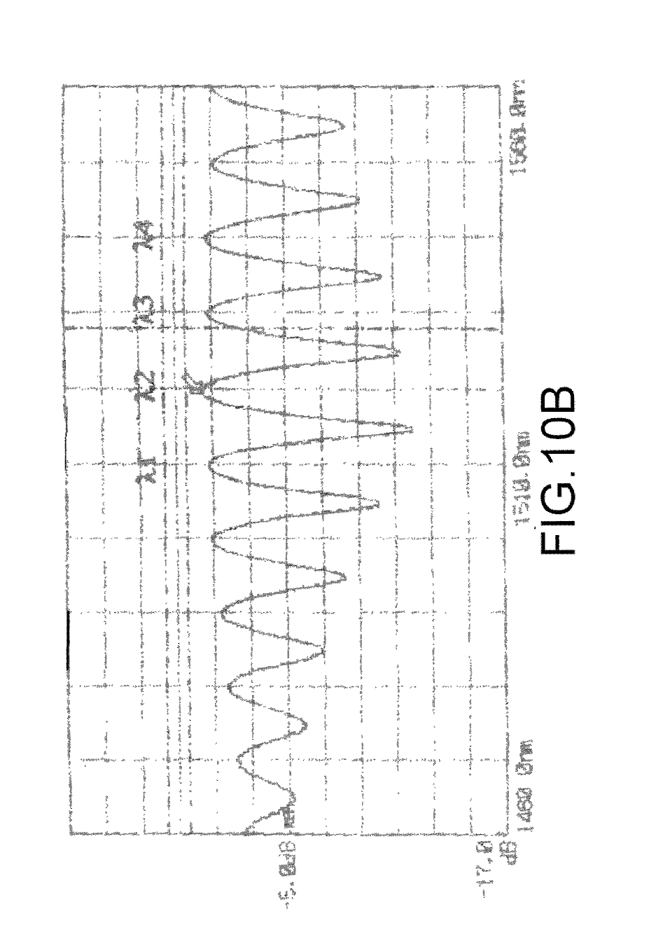

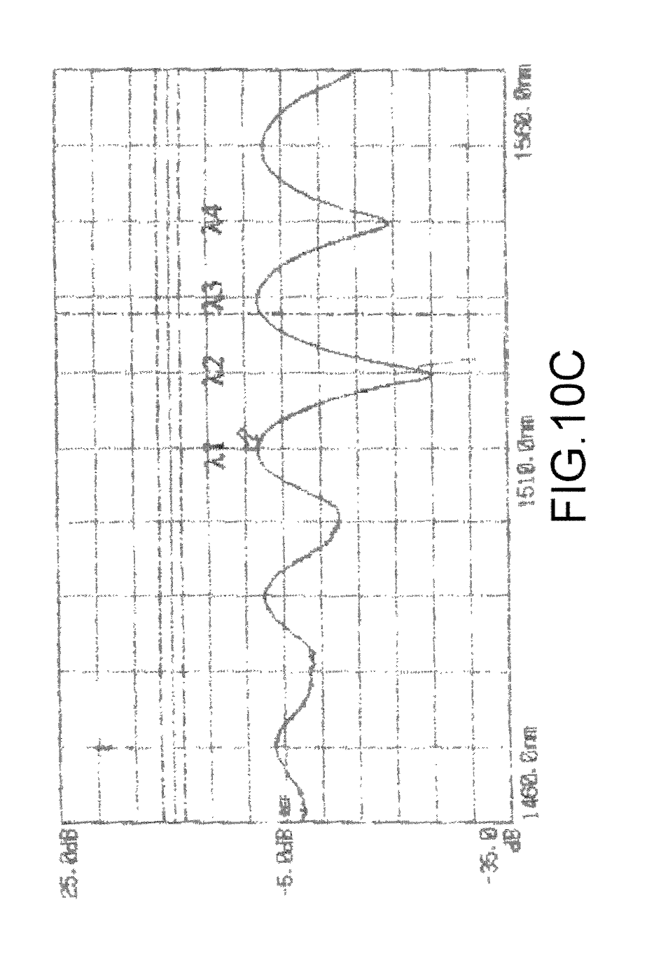

FIG. 10A schematically shows a second example of the optical function module shown in FIG. 7. This structure can be used for adding and dropping one or a number of special wavelengths within optical signals.

The optical function module 130 comprises a wavelength managing module 150, an optical add/drop multiplexer (OADM) 154, and an optical isolator 156. As an example, the optical isolator 156 is a single-stage or multi-stage polarization insensitive fiber isolator. The wavelength managing module 150 has four ports P1˜P4 for input/output. Port P1 of the wavelength managing module 150 is optically coupled to the transmission path 132, and used for receiving the optical signals having wavelengths λ1, λ3, . . . , λ2n−1 or outputting the optical signals having wavelengths λ2, λ4, . . . , λ2m, shown in FIG. 7. Port P4 of the wavelength managing module 150 is optically coupled to the optical transmission path 134, and used for receiving the optical signals having wavelengths λ2, λ4, . . . , λ2m or outputting the optical signals having wavelengths λ1, λ3, . . . , λ2n−1, shown in FIG. 7. Port P2 of the wavelength managing module 150 is coupled to the adding end of the OADM 154, and the optical isolator 156 is coupled between the OADM 154 and port P3 of the wavelength managing module 150.

If the optical isolator 156 is not installed between the OADM 154 and port P3 of the wavelength managing module 150, the optical isolation becomes unstable. For example, the optical signals become unstable if the polarization states of the transmitted optical signals between the fibers or elements. As shown in FIG. 10B, when the fiber between port P2 and port P3 is disturbed, the spectrum is changed. In contrast, after the optical isolator 156 is inserted, optical signals pass through the wavelength managing module 150 twice, and the isolation becomes deeper in the portion marked λ2 shown in FIG. 10C.

The optical signals having wavelengths λ1, λ3, . . . , λ2n−1 emitted from the first optical transceiver 110 are transmitted to port P1 of the wavelength managing module 150, passed through the wavelength managing module 150 and then outputted at port P2. The optical signals are then transmitted to the OADM 154 through the optical transmission path 152. Similarly, the optical signals having wavelengths λ2, λ4, . . . , λ2m, emitted from the second optical transceiver 120, are transmitted to port P4 of the wavelength managing module 150, passed through the wavelength managing module 150 and then outputted at port P2. The optical signals having wavelengths λ2, λ4, . . . , λ2m are then transmitted to the OADM 154 through the optical transmission path 152. Accordingly, port P2 of the wavelength managing module 150 outputs optical signals having all wavelengths λ1, λ2, . . . , λ2m. The OADM 154 performs an add/drop operation for one or a number of special wavelengths within the optical signals. Thereafter, the signals from the OADM 154 are transmitted to the optical isolator 156 and then to port P3 of the wavelength managing module 150. The optical signals having wavelengths λ1, λ3, . . . , λ2n−1 are then transmitted to the second optical transceiver 120 through port P4, and the optical signals having wavelengths λ2, λ4, . . . , λ2m are then transmitted to the first optical transceiver 110 through port P1.

The optical isolator 156 is used for keeping the optical signals propagating in one direction from port P2 to port P3, avoiding unnecessary noises resulted from an interference effect within the wavelength managing module 150.

When a WDM-based optical communication system is used for a long-haul interexchange carrier route, the transmission path (standard SMF) is usually in an order of hundreds of kilometers. Chromatic dispersion of the optical signals having multiple wavelengths results from propagating such a long distance. The optical signals are deformed due to the chromatic dispersion and cannot be kept as the same waveforms emitted from the transmitter. Therefore, it is necessary to compensate the chromatic dispersion for the long-haul WDM optical communication.

FIG. 11 schematically shows a third example of the optical function module shown in FIG. 7. The optical function module 130 shown in FIG. 11 can compensate for the chromatic dispersion due to the long-distance propagation.

The optical function module 130 of FIG. 11 comprises a wavelength managing module 160, an optical circulator 164, and a chromatic dispersion compensator 166. The wavelength managing module 160 has four ports P1˜P4. Port P1 of the wavelength managing module 160 is optically coupled the optical transmission path 132 and used for receiving the optical signalshaving wavelengths λ1, λ3, . . . , λ2n−1 or outputting the optical signals having wavelengths λ2, λ4, . . . , λ2m, shown in FIG. 7. Port P4 of the wavelength managing module 160 is optically coupled to the optical transmission path 134, and used for receiving the optical signals having wavelengths λ2, λ4, . . . , λ2m or outputting the optical signals having wavelengths λ1, λ3, . . . , λ2n−1, shown in FIG. 7. Port P2 of the wavelength managing module 160 is connected to port 1 of the circulator 164, and port 2 of the circulator 164 is connected to the chromatic dispersion compensator 166 through the optical transmission path 164a. Port 3 of the circulator 164 is connected to port P3 of wavelength managing module 160. As an example, the chromatic dispersion compensator 166 can comprise an optical circulator and an optical fiber grating.

The operation of the wavelength managing module 160 is the same as the above description. A combined single optical signal including wavelengths λ1, λ2, . . . , λ2m, are transmitted to port 1 of the circulator 164 and then redirected to port 2 for output. The output optical signal is further transmitted to the chromatic dispersion compensator 166 through the optical transmission path 164a for reshaping the optical signal to restore its original waveform and compensating the chromatic dispersion due to long-distance propagation. The reshaped optical signal is reflected by the chromatic dispersion compensator 166 and then transmitted to port 2 of the optical circulator 164. The reshaped optical signal is redirected the optical signal to port 3 and then transmitted to port P3 of the wavelength managing module 160. Then, the optical signals having wavelengths λ1, λ3, . . . , λ2n−1 are transmitted to the second optical transceiver 120 through port P4, and the optical signals having wavelengths λ2, λ4, . . . , λ2m are transmitted to the first optical transceiver 110 through port P1.

The optical circulator 160 can be a three-port optical circulator as mentioned above, or a six-port optical circulator.

The present invention further provides a system comprising a number of optical communication systems. The optical signals propagate on different transmission paths. Descriptions for discussing how to exchange the information among these optical communication systems.

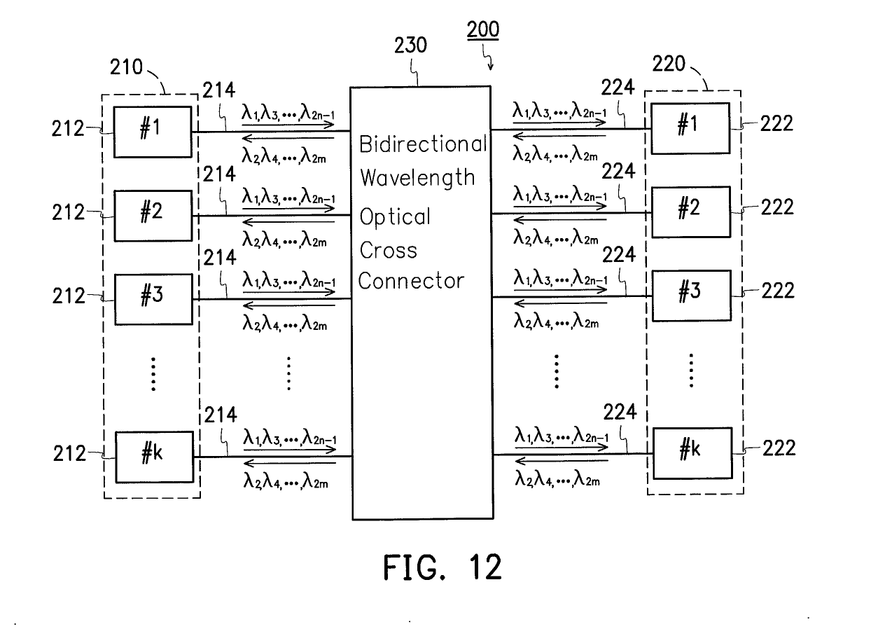

FIG. 12 schematically shows a block diagram of a system containing a number of optical communication systems for exchanging the information among these optical communication systems.

The system 200 comprises a first optical transceiving node 210 having a number of first optical transceivers 212, such as numerals #1˜#k, and a second optical transceiving node 220 having a number of second optical transceivers 222, such as numerals #1˜#k. The numbers of the transceivers 212 and 222 are the same. The first optical transceiving node 210 and the second optical transceiving node 220, respectively, use a number of optical transmission paths 214, 224 to connect to a bi-directional wavelength crossconnect 230. Each of optical transmission paths 214 is coupled to each of the first optical transceivers 212, and each of the optical transmission paths 224 is coupled to each of the second optical transceivers 222. In addition, one or more bi-directional wavelength crossconnects can be used in the system 200.

Each of the optical transmitters 212 of the first optical transceiving node 210, such as the optical transmitter 212 of number #1, transmits optical signals with wavelengths λ1,λ3, . . . ,λ2n−1 to the bi-directional wavelength crossconnect 230 through one of the optical transmission paths 214, and receives optical signals having wavelengths λ2,λ4, . . . ,λ2m from the bi-directional wavelength crossconnect 230 through one of the optical transmission paths 214 corresponding to the optical transmitter 212 of number #1. Similarly, each of the optical transmitters 222 of the second optical transceiver node 220, such as the optical transmitter 222 of number #1, transmits optical signals having wavelengths λ2,λ4, . . . ,λ2m to the bi-directional wavelength crossconnect 230 through one of the optical transmission paths 224, and receives optical signals with wavelengths λ1,λ3, . . . ,λ2n−1 from the bi-directional wavelength crossconnect 230 through one of the optical transmission paths 224 corresponding to the optical transmitter 222 of number #1.

The bi-directional wavelength crossconnect 230 is used for transferring the optical signals from one bi-directional optical communication system to another bi-directional optical communication system. For example, the bi-directional wavelength crossconnect 230 can be used for transferring the optical signals having wavelengths λ1, λ3, . . . , λ2n−1 which are emitted from one of the optical transmitters 212 of the first optical transceiving node 210 to any one of the optical transmitters 222 of the second optical transceiving node 220, such as one of the transmitters 222 selected from #1˜#k.

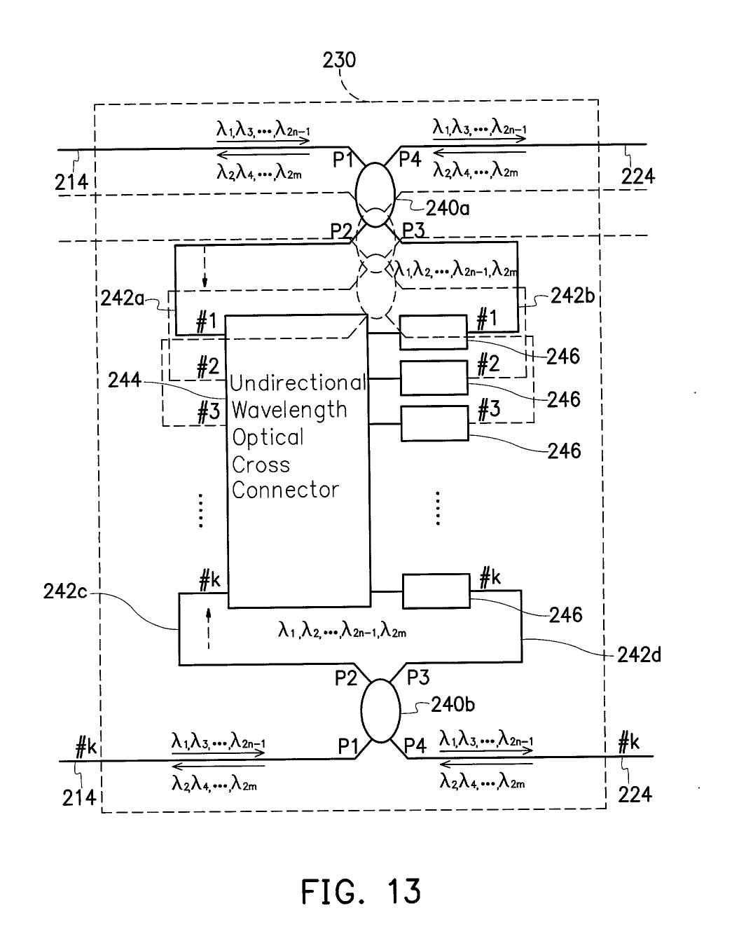

FIG. 13 schematically shows a detailed structure of the bi-directional wavelength crossconnect 230 shown in FIG. 12. The bi-directional wavelength crossconnect 230 comprises a number of wavelength managing modules 240a, . . . ,240b, a unidirectional wavelength optical crossconnect 244, and a number of optical isolators 246.

As shown in FIG. 13, which is provided as an example, the first wavelength managing module 240a connects to the #1 optical transmitters 212, 222 of the first and the second optical transceiving nodes 210, 220 respectively through the optical transmission paths 214, 224 respectively corresponding to the #1 optical transmitters 212, 222. The set marked by #1 is described as following for discussing the operation of the bi-directional wavelength crossconnect 230 in detail, and the other sets marked by #2˜#k are the same.

Port P1 of the wavelength managing modules 240a connects to the #1 optical transmitter 212 of the optical transceiving node 210 through the optical transmission path 214 corresponding to the #1 optical transmitter 212, and port P4 of the wavelength managing modules 240a connects to the #1 optical transmitter 222 of the optical transceiving node 220 through the optical transmission path 224 corresponding to the #1 optical transmitter 222. Port P2 of the wavelength managing modules 240a is connected to the #1 input of the unidirectional wavelength optical crossconnect 244. The #1 output of the unidirectional wavelength optical crossconnect 244 is connected to port P3 of the wavelength managing modules 240a through the optical isolator 246. The input/output numbers (#1˜#k) of the unidirectional wavelength optical crossconnect 244 are consistent with the number of the transmitters 212 or 222.

Port P1 of the #k wavelength managing modules 240b connects to the #k optical transmitter 212 of the optical transceiving node 210 through the optical transmission path 214 corresponding to the #k optical transmitter 212, and port P4 of the #k wavelength managing modules 240b connects to the #k optical transmitter 222 of the optical transceiving node 220 through the #k optical transmission path 224 corresponding to the #k optical transmitter 222. Port P2 of the #k wavelength managing modules 240b is connected to the #k input of the unidirectional wavelength optical crossconnect 244. The #k output of the unidirectional wavelength optical crossconnect 244 is connected to port P3 of the #k wavelength managing modules 240b through the #k optical isolator 246.

Namely, if there are k optical transmission paths between the first and the second optical transceiving nodes 210, 220, the unidirectional wavelength optical crossconnect 244 then comprises at least k input/output ends (#1˜#k). Each of the input/output ends #1˜#k connects to one wavelength managing module. As an example, the #1 wavelength managing module 240a connects to the #1 input/output of the unidirectional wavelength optical crossconnect 244, and the #k wavelength managing module 240b connects to the #k input/output of the unidirectional wavelength optical crossconnect 244. Other wavelength managing modules are represented by a dash line as shown in FIG. 13.

Accordingly, after optical signals having wavelengths λ1,λ3, . . . ,λ2n−1 from the first optical transceiving node 210 and optical signals having wavelengths λ2,λ4, . . . ,λ2m from the second optical transceiving node 220 are combined, the combined optical signals are transmitted to the unidirectional wavelength crossconnect 244 through the #1˜#k optical transmission paths 242a from port P2 of the wavelength managing modules. Afterwards, the optical signals are transmitted to the second optical transceiving node 220. As an example, after the optical signal having wavelength λ1, emitted from the #1 first optical transceiver 212 of the first optical transceiving node 210, is transmitted to the unidirectional wavelength crossconnect 244, it is then switched to such as the #2 output of the unidirectional wavelength crossconnect 244 under a predetermined condition. After the optical signal having wavelength λ1, emitted from the #2 first optical transceiver 212 of the first optical transceiving node 210, is transmitted to the unidirectional wavelength crossconnect 244, it is then switched to the #2 output of the unidirectional wavelength crossconnect 244 under a predetermined condition. Or after the optical signal having wavelength λ1, emitted from the #2 first optical transceiver 212 of the first optical transceiving node 210 is transmitted to the unidirectional wavelength crossconnect 244, it is switched to the #3 output of the unidirectional wavelength crossconnect 244 under a predetermined condition; and after the optical signal having wavelength λ1, emitted from the #3 first optical transceiver 212 of the first optical transceiving node 210 is transmitted to the unidirectional wavelength crossconnect 244, it is switched to the #1 output of the unidirectional wavelength crossconnect 244 under a predetermined condition.

After the unidirectional wavelength crossconnect 244 exchanges the wavelengths, the each of combined optical signals that have passed through the optical isolators 246, propagates on the optical transmission path 242b and contains wavelengths λ1,λ2, . . . ,λ2m. The combined optical signal is then transmitted to port P3 of one wavelength managing module (such as 240a). The optical signal having wavelengths λ1,λ3, . . . ,λ2n−1 then propagate from each port P4 of the wavelength managing module to the second optical transceiving node 220 through the optical transmission path 224. Similarly, the optical signal having wavelengths λ2,λ4, . . . ,λ2m propagate from each port P1 of the wavelength managing module to the first optical transceiving node 210 through the optical transmission path 214.

Typically, the unidirectional wavelength crossconnect 244 comprises a number of demultiplexers and multiplexers for processing the optical signals having wavelengths λ1,λ2, . . . ,λ2m and a number of multi-port optical switches. For example, according to the preferred embodiment of the present invention, the unidirectional wavelength crossconnect 244 comprises a combination of k demultiplexers and k multiplexers for wavelengths λ1,λ2, . . . ,λ2m, and m+n multi-port optical switches having k×k ports (k inputs and k outputs).

Accordingly, for the foregoing discussions and descriptions, there are at least the following features or advantages provided in the present invention.

According to the optical function module for bi-directional wavelength-division multiplexer (WDM) optical communication system of the present invention, the channel numbers, which means the capability for processing the number of the optical signals of different wavelengths, can be expanded easily and does not increase the system complexity.

According to the optical function module for bi-directional wavelength-division multiplexer (WDM) optical communication system of the present invention, insertion-loss is significantly reduced.

According to the optical function module for bi-directional wavelength-division multiplexer (WDM) optical communication system of the present invention, it provides high isolation property. The optical signals transmitted between two optical transceiving nodes pass through the wavelength managing module twice. Therefore, the optical isolation is significantly increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical function module for bi-directional wavelength-division multiplexer (WDM) optical communication system, comprising:
at least one wavelength managing module having a plurality of ports, the wavelength managing module optically coupling between a first optical transceiver and a second optical transceiver, wherein the first and the second optical transceivers provide a first and a second optical channels respectively for transmitting a plurality of optical signals with different wavelengths; and
at least one uni-directional optical function module having a high isolation function, and coupling to the ports of the wavelength managing module.

2. The optical function module of claim 1, wherein the uni-directional optical function module having a high isolation function is an optical amplifier module, and couples to the ports of the wavelength managing module.

3. The optical function module of claim 1, wherein the uni-directional optical function module having a high isolation function is a chromatic dispersion compensator coupling to the ports of the wavelength managing module.

4. The optical function module of claim 3, wherein the chromatic dispersion compensator further comprises an optical circulator and an optical fiber grating.

5. The optical function module of claim 4, wherein the optical circulator of the optical dispersion compensator is a three-port circulator.

6. The optical function module of claim 4, wherein the optical circulator of the optical dispersion compensator is a six-port circulator.

7. The optical function module of claim 1, wherein the wavelength managing module is a multi-window wavelength-division multiplexer (MWDM).

8. An optical function module for bi-directional wavelength-division multiplexer (WDM) optical communication system, comprising:
at least one wavelength managing module having a plurality of ports, the wavelength managing module optically coupling between a first optical transceiver and a second optical transceiver, wherein the first and the second optical transceivers provides a first and a second optical channels respectively for transmitting a plurality of optical signals with different wavelengths;
at least one uni-directional optical function module coupling to the ports of the wavelength managing module; and
at least one optical isolator optically coupled between the wavelength managing module and the uni-directional optical function module.

9. The optical function module for bi-directional wavelength-division multiplexer (WDM) optical communication system of claim 8, wherein the uni-directional optical function module comprises at least one optical add/drop module coupling to the ports of the wavelength managing module.

10. The optical function module for bi-directional wavelength-division multiplexer (WDM) optical communication system of claim 8, wherein the uni-directional optical function module comprises at least one uni-directional optical crossconnect coupling to the ports of the wavelength managing module.

11. The optical function module for bi-directional wavelength-division multiplexer (WDM) optical communication system of claim 8, wherein the wavelength managing module comprises a multi-window wave-division multiplexer (MWDM).

12. A bi-directional wavelength multiplexer optical communication system, for automatically switching optical signals, comprising:
a plurality of wavelength managing modules, each of the wavelength managing modules having a plurality of ports, and one of the ports connecting to a first optical transceiver and another port connecting to a second optical transceiver, the first and the second optical transceivers respectively providing a first and a second optical channels for transmitting a plurality of optical signals with different wavelengths;
at least one uni-directional wavelength crossconnect optically connecting between the ports of the wavelength managing modules; and
a plurality of optical isolators, each of the optical isolators optically connecting between the uni-directional optical crossconnect and each of the wavelength managing modules.

13. The bi-directional wavelength multiplexer optical communication system of claim 12, wherein each of the wavelength managing modules comprises at least one multi-window wave-division multiplexer (MWDM).

14. The bi-directional wavelength multiplexer optical communication system of claim 12, wherein the number of the wavelength managing modules is consistent with the number of input optical transmission paths of the bi-directional wavelength multiplexer optical communication system.

15. The bi-directional wavelength multiplexer optical communication system of claim 12, wherein the number of the optical isolators is consistent with the number of input optical transmission paths of the bi-directional wavelength multiplexer optical communication system.
